(19) United States
(12) Patent Application Publication
(10) Pub. No.: US 2026/0175821 A1
(43) Pub. Date: Jun. 25, 2026

(54) ACTUATING DEVICE FOR A BRAKE SYSTEM

(71) Applicant: Robert Bosch GmbH, Stuttgart (DE)

(72) Inventors: Christoph Voelkel, Waltenhofen (DE); Alice Schacherl, Burgberg (DE); Ben Ferguson, Rettenberg (DE); Bernd Lutz, Kempten (DE); Guenter Escher, Oberstdorf (DE); Ignaz Hatt, Buchenberg (DE); Klaus Lerchenmueller, Rettenberg (DE); Martin Winkler, Sonthofen (DE); Sven Langhorst, Kempten (DE)

(21) Appl. No.: 18/854,995

(22) PCT Filed: May 25, 2023
(86) PCT No.: PCT/EP2023/064030

§ 371 Date: Oct. 8, 2024

(30) Foreign Application Priority Data
May 30, 2022 (DE) 10 2022 205 435.0

(51) Int. Cl. B60T 7/04; B60T 7/06; B60T 11/18; B60T 13/74

(52) U.S. Cl. CPC B60T 7/042; B60T 7/06; B60T 11/18; B60T 13/745; B60T 2220/04

(57) ABSTRACT

An actuating device for a brake system. The actuating device includes an actuatable master brake cylinder, with a transmission device, which includes a displaceably mounted transmission element, with an electric motor for driving the transmission device, with a displaceably mounted pressure force transmitter, which is connected to an input rod in such a way that the pressure force transmitter is displaceable by the input rod, wherein the master brake cylinder is actuatable both by a displacement of the transmission element as well as by a displacement of the pressure force transmitter, and with a sensor, which includes a first sensor part that is displaceable together with the pressure force transmitter and a second sensor part that is displaceable together with the transmission element. The first and the second sensor parts are displaceably mounted on a common carrier element of the sensor.

### FIELD

The present invention relates to an actuating device for a brake system, which comprises an actuatable master brake cylinder, with a transmission device, which comprises a displaceably mounted transmission element, with an electric motor for driving the transmission device, with a displaceably mounted pressure force transmitter, which is connected to an input rod in such a way that the pressure force transmitter is displaceable by the input rod, wherein the master brake cylinder is actuatable both by a displacement of the transmission element as well as by a displacement of the pressure force transmitter, and with a sensor, which comprises a first sensor part that is displaceable together with the pressure force transmitter and a second sensor part that is displaceable together with the transmission element.

### BACKGROUND INFORMATION

A hydraulic brake system of a motor vehicle typically has multiple friction braking devices, which are hydraulically connected to a master brake cylinder of the brake system. If the master brake cylinder is actuated, then a hydraulic fluid in slave cylinders of the friction braking devices is displaced so that the friction braking devices then produce a friction braking torque. An actuating device is typically present for actuating the master brake cylinder. With the increasing electrification of motor vehicles, actuating devices of brake systems are also increasingly electrified. An actuating device of the kind mentioned at the outset described, for example, in German Patent Application No. DE 10 2019 203 511 A1. The actuating device has a transmission device with a displaceably mounted transmission element. The transmission device is drivable by an electric motor of the actuating device. In addition, the actuating device has a displaceable pressure force transmitter. The pressure force transmitter is connected to an input rod in such a way that the pressure force transmitter is displaceable by the input rod. If the actuating device is installed in the brake system as intended, then the master brake cylinder is actuatable both by a displacement of the transmission element as well as by a displacement of the pressure force transmitter. The actuating device also has a sensor, which has a first sensor part that is displaceable along with the pressure force transmitter and a second sensor part that is displaceable along with the transmission element. The sensor is able to detect a displacement position of the pressure force transmitter relative to a displacement position of the transmission element. In the actuating device described in German Patent Application No. DE 10 2019 203 511 A1, the first sensor part is a measuring transducer of the sensor. The second sensor part is a receiver of the sensor. The first sensor part is fastened to the pressure force transmitter and the second sensor part is fastened to the transmission element.

### SUMMARY

In an actuating device according to an example embodiment of the present invention, the first sensor part and the second sensor part are displaceably mounted on a common carrier element of the sensor. By mounting both the first sensor part as well as the second sensor part on the common carrier element, the elements of the sensor can be handled together in a simple manner as an assembly. This markedly simplifies the installation of the sensor in the actuating device as well as the removal of an installed sensor as compared to conventional solutions. The carrier element is preferably made of plastic.

According to a preferred specific embodiment of the present invention, it is provided that the carrier element has a frame-shaped design and that the first and the second sensor parts are displaceably mounted in a frame opening of the carrier element. By being mounted in the frame opening, the first and the second sensor parts are protected by the carrier element against damage. The frame-shaped carrier element preferably comprises two first legs oriented in the displacement direction of the sensor units and two second legs oriented perpendicularly to the displacement direction, so that the frame has a rectangular shape. Particularly preferably, the sensor parts are displaceably supported by the first legs of the frame-shaped carrier element. The first legs thus contribute to supporting the sensor parts.

A preferred specific embodiment of the present invention provides for a, particularly metallic, guide rod to be fastened to the carrier element, and for the first sensor part and the second sensor part to be displaceably supported by the guide rod. The guide rod makes it possible to achieve a mechanically particularly robust support of the first sensor part and of the second sensor part. The first and the second sensor parts are preferably slipped or slid onto the guide rod. Particularly preferably, multiple guide rods arranged in parallel to one another are fastened on the carrier element, the first sensor part and the second sensor part then being displaceably mounted on the multiple guide rods.

According to an example embodiment of the present invention, the first and the second sensor parts are preferably mounted on the carrier element one behind the other in the direction of displacement. Such an arrangement of the sensor parts allows for the implementation of a sensor having a small width. According to an alternative specific embodiment of the present invention, the sensor parts are arranged for example side by side in the direction of displacement.

A preferred specific embodiment of the present invention provides for the actuating device to comprise a housing, in which the transmission element and the pressure force transmitter are at least partially situated, and for the sensor to be fastened to the housing. This specific embodiment of the actuating device of the present invention is mechanically particularly robust. In particular, the sensor is fastened to the housing by the carrier element. The sensor is preferably fastened to the housing in removable fashion. This simplifies the exchange of an installed sensor. Particularly preferably, the sensor is fastened to the housing by a releasable screw connection.

A preferred specific embodiment of the present invention provides for the sensor to be inserted into an opening of an outer wall of the housing. The insertion into the opening achieves the result that both the mechanical coupling of the first sensor part and of the second sensor part to the pressure force transmitter and, respectively, to the transmission element as well as an electrical connection to a control device situated outside of the housing can be accomplished in a technically simple manner. The sensor is preferably inserted into the opening in such a way that the first sensor part and the second sensor part are facing an interior of the housing.

A preferred specific embodiment of the present invention provides for a first driver element to be fastened to the pressure force transmitter, the first driver element being connected to the first sensor part by a form-locking connection. The form-locking connection achieves the result that the first sensor part is securely displaced along with the pressure force transmitter, the form-locking connection being designed for this purpose to transfer at least the forces of the pressure force transmitter acting in the displacement direction onto the first sensor part. For this purpose, the first driver element may be fastened both directly as well as indirectly to the pressure force transmitter. Alternatively or additionally, the actuating device preferably has a second driver element fastened to the transmission element, the second driver element being fastened to the second sensor part by a form-locking connection.

According to an example embodiment of the present invention, the first driver element preferably cooperates with a fork-shaped retaining structure of the first sensor part for establishing the form-locking connection. Such a form-locking connection securely ensures that the first sensor part is displaced along with the pressure force transmitter. Moreover, the form-locking connection is easy to establish, namely, by inserting the first driver element into the fork-shaped retaining structure. Alternatively or additionally, the second driver element cooperates with a fork-shaped retaining structure of the second sensor part for establishing the form-locking connection.

A preferred specific embodiment of the present invention provides for the first driver element to be fastened to the first sensor part by a snap-in connection or a clamping connection. This ensures a mechanically particularly robust connection between the first driver element and the first sensor part, so that the connection also withstands vibrations of the actuating device for example. Furthermore, it is easy to establish a snap-in connection or a clamping connection when installing the sensor into the actuating device, for example by plugging together the first driver element and the first sensor part. The snap-in connection or the clamping connection are preferably designed to be releasable. This has the advantage that an exchange of the sensor is readily possible. The second driver element is preferably fastened on the second sensor part by an, in particular releasable, snap-in connection or an, in particular releasable, clamping connection.

A preferred specific embodiment of the present invention provides for the sensor to comprise a circuit board fastened on the carrier element, on which at least one receiver coil is formed. The receiver coil is thus formed by conductor tracks of the circuit board. Such a design of the receiver coil can be realized in a technically simple and cost-effective manner. Fastening the circuit board on the carrier element simplifies the electrical connection of the circuit board or of the receiver coil to a control device for example. If the circuit board or the receiver coil were displaceably mounted on the carrier element, then the electrical connection to a control device would at least be rendered more difficult. The receiver coil makes it possible to implement a contactless detection of the displacement position of the first sensor part and of the second sensor part. The sensor is preferably designed as an inductive sensor. Particularly preferably, the circuit board comprises a transmitter coil and two receiver coils. As mentioned above, the carrier element preferably has a frame-shaped design. The circuit board is then preferably situated in such a way that it covers or closes the frame opening of the carrier element. According to an alternative specific embodiment of the present invention, the first sensor part or the second sensor part is designed as a receiver. The second sensor part or the first sensor part is then designed as a measurement transducer.

A preferred specific embodiment of the present invention provides for the circuit board to comprise at least one electrically conductive contact plate for electrically contacting a control device. Such contact plates can be contacted in a technically simple manner, for example by electrically conductive contact springs on the side of the control device. As mentioned above, the sensor preferably comprises one transmitter coil and two receiver coils. The circuit board then preferably comprises six electrically conductive contact plates, each of the coils respectively being assigned two of the contact plates. Particularly preferably, the contact plates are arranged in a row one behind the other.

A preferred specific embodiment of the present invention provides for the first sensor part to comprise an electrically conductive material and to be situated in such a way that an electrical voltage of the receiver coil can be influenced by a displacement position of the first sensor part, and/or for the second sensor part to comprise an electrically conductive material and to be situated in such a way that the electrical voltage of the receiver coil can be influenced by a displacement position of the second sensor part. A particularly advantageous inductive sensor is thereby realized. Particularly preferably, the first and/or the second sensor part respectively comprise a base body made of plastic, the electrically conductive material being situated on a side of the base bodies facing the receiver coil.

According to an example embodiment of the present invention, the actuating device preferably comprises a control device, which is situated in such a way on the housing of the actuating device that the control device covers the sensor. By such an arrangement of the control device, the sensor is protected by the control device against external influences. Moreover, the connection of the sensor to the control device is simplified because the control device is located in the immediate vicinity of the sensor. The control device is preferably electrically connected to the circuit board. Particularly preferably, the electrical connection is realized by contact springs on the side of the control device, which are in contact with the above-mentioned contact plates on the side of the circuit board. The control device is preferably designed to control the electric motor as a function of a sensor signal of the sensor.

A preferred specific embodiment of the present invention provides for the control device to comprise a control device housing, and for the sensor to be situated in an opening of an outer wall of the control device housing. This further increases the protection of the sensor against external influences and also further simplifies the connection of the sensor to the control device. The sensor preferably extends into the control device in such a way that the circuit board of the sensor is situated in an interior of the control device housing.

The present invention is explained in more detail below with reference to the figures.

### BRIEF DESCRIPTION OF THE DRAWINGS

FIG. 1 shows a perspective illustration of an actuating device for a brake system, according to an example embodiment of the present invention.

FIG. 2 shows a sectional view of the actuating device, according to an example embodiment of the present invention.

FIG. 3 shows a sensor of the actuating device, according to an example embodiment of the present invention.

FIG. 4 shows a further illustration of the sensor, according to an example embodiment of the present invention.

FIG. 5 shows the sensor coupled to elements of the actuating device, according to an example embodiment of the present invention.

FIG. 6 shows a housing of the actuating device, according to an example embodiment of the present invention.

FIG. 7 shows a further illustration of the actuating device, according to an example embodiment of the present invention.

### DETAILED DESCRIPTION OF EXAMPLE EMBODIMENTS

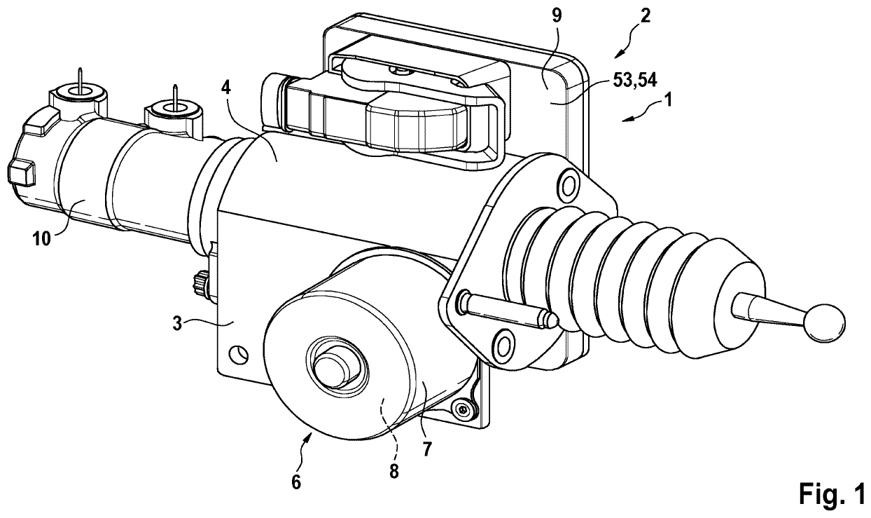

FIG. 1 shows a perspective view of an actuating device 1 for a brake system 2 of a motor vehicle that is not shown in more detail here. The actuating device 1 comprises a housing 3. The housing 3 has a tubular design and thus has a circumferential outer wall 4, which encloses an interior 5 of the housing 3. The actuating device 1 additionally comprises a drive unit 6, which is situated on the housing 3. The drive unit 6 comprises an electric motor 8, which is situated in a motor housing 7 is therefore not visible in FIG. 1. The actuating device 1 furthermore comprises a control device 9. The control device 9 is situated on the housing 3 on a side of the housing 3 facing away from the drive unit 6. The control device 9 is designed to control the electric motor 8. On a front side of the housing 3, a master brake cylinder 10 is situated, in which in the present case two hydraulic pistons 11 are displaceably mounted. If the actuating device 1 is installed as intended in the brake system 2, then the master brake cylinder 10 is fluidically connected to slave cylinders of friction brake devices of the brake system 2.

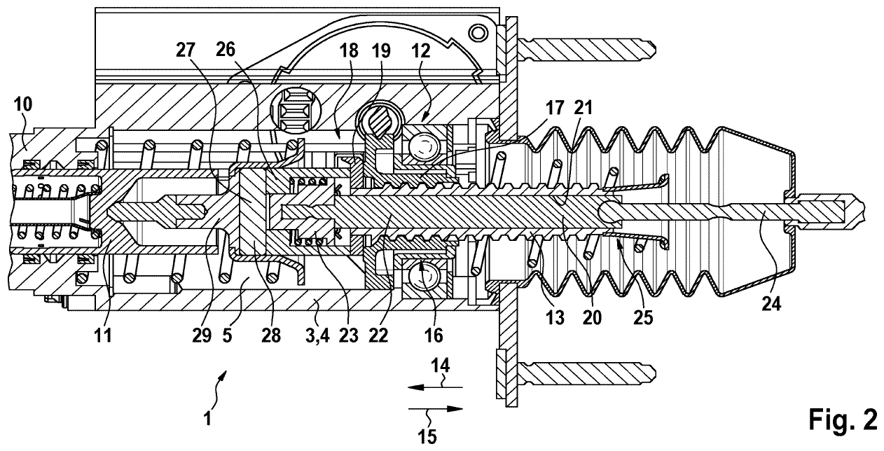

FIG. 2 shows a longitudinal section of the actuating device 1. The actuating device 1 comprises a transmission device 12. The transmission device 12 is operatively connected to the electric motor 8 in such a way that the transmission device 12 is drivable by the electric motor 8. The transmission device 12 comprises a displaceably mounted transmission element 13, the transmission element 13 being situated at least partially in the housing 3. The transmission element 13 is displaceable in a first direction 14 and in a second direction 15 opposite to the first direction 14. In the present case, the transmission element 13 is a threaded spindle 13, which is part of a spindle transmission 16. The spindle transmission 16 comprises, in addition to the threaded spindle 13, a rotationally mounted spindle nut 17. An internal toothing of the spindle nut 17 meshes with an external toothing of the threaded spindle 13. In order to ensure that the threaded spindle 13 is displaced when the spindle nut 17 rotates, rather than rotating along with the spindle nut 17, an anti-rotation device 18 is assigned to the threaded spindle 13. For this purpose, there exists an anti-rotation element 19, which is fastened on the threaded spindle 13, in the present case on an end of the threaded spindle 13 facing the master brake cylinder 10. The anti-rotation element 19 cooperates with the housing 3 to form the anti-rotation device 18. In the present case, a cup-shaped thrust body 26 is fastened on the anti-rotation element 19.

The actuating device 1 furthermore comprises a pressure force transmitter 20 mounted displaceably relative to the transmission element 13, the pressure force transmitter 20 also being situated at least partially in the housing 3. The pressure force transmitter 20 is displaceable in the first direction 14 and in the second direction 15. In the present case, the pressure force transmitter 20 is mounted in an opening 21 of the transmission element 13. According to the exemplary embodiment shown in FIG. 2, the pressure force transmitter 20 has a multi-part design. For this purpose, the pressure force transmitter 20 comprises a rod-shaped section 22, which is situated in the opening 21. Additionally, the pressure force transmitter comprises a pressure cap 23, which is situated at an end of the pressure force transmitter 20 facing the master brake cylinder 10. The pressure cap 23 is fastened on the rod-shaped section 22, in the present case by crimping. An end of the pressure force transmitter 20 facing away from the master brake cylinder 10 is connected to an input rod 24 so that the pressure force transmitter 20 is displaceable by the input rod 24. In the present case, the pressure force transmitter 20 is connected to the input rod 24 by a ball-and-socket joint 25. An end of the input rod 24 facing away from the pressure force transmitter 20 is fastened to a brake pedal (not shown).

The master brake cylinder 10 is actuatable both by displacement of the transmission element 13 as well as by a displacement of the pressure force transmitter 20. An actuation of the master brake cylinder 10 is to be understood as a displacement of the hydraulic pistons 11 in the first direction 14. If the actuating device 1 is installed as intended in the brake system 2, then a hydraulic fluid is thereby displaced from the master brake cylinder 10 into the slave cylinders of the friction brake devices so that the friction brake devices then produce a friction braking torque. In the present case, the transmission element 13 and the pressure force transmitter 20 are operatively connectible or operatively connected to the hydraulic piston 11 by a coupling element 27. The coupling element 27 comprises an elastically deformable coupling disk 28 and a rigid pressure rod 29. If the master brake cylinder 10 is actuated by the electric motor 8, then the electric motor 8 acts upon the hydraulic pistons 11 by way of the transmission element 13, the anti-rotation element 19, the thrust body 26 and the coupling element 27. If the master brake cylinder 10 is actuated by an actuation of the brake pedal, then the brake pedal acts upon the hydraulic pistons 11 by way of the input rod 24, the pressure force transmitter 20 and the coupling element 27.

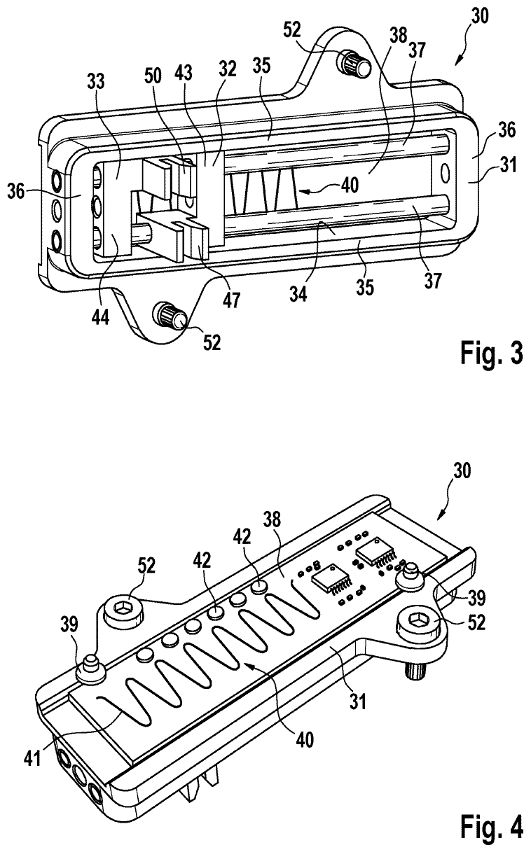

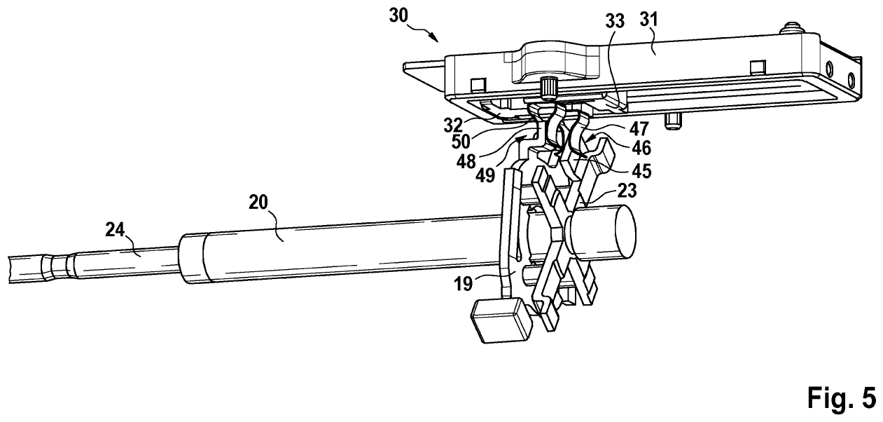

The actuating device 1 also comprises a sensor 30. Sensor 30 is designed to monitor a displacement position of the pressure force transmitter 20 as well as a displacement position of the transmission element 13. The design of the sensor 30 is explained in more detail below with reference to FIGS. 3, 4 and 5. For this purpose, FIGS. 3 and 4 respectively show a perspective view of sensor 30. FIG. 5 shows the sensor 30 together with further elements of the actuating device 1.

Sensor 30 comprises a carrier element 31. Carrier element 31 is made of a plastic. A first sensor part 32 and a second sensor part 33 are displaceably mounted on carrier element 31. As can be seen from the figures, the sensor parts 32 and 33 are arranged one behind the other in the direction of displacement.

According to the exemplary embodiment illustrated in the figures, the carrier element 31 has a frame-shaped design, so that the carrier element 31 has a frame opening 34. The carrier element 31 comprises two first legs 35 oriented in parallel to each other and two second legs 36 oriented in parallel to each other, the second legs 36 being oriented perpendicularly to the first legs 35. The first legs 35 are longer than the second legs 36, so that the carrier element 31 as a whole has an elongated design. The legs 35 and 36 together form or define the frame opening 34. The sensor parts 32 and 33 are displaceably mounted in the frame opening 34, so that the sensor parts 32 and 33 are protected by the carrier element 31. Two metal guide rods 37 are fastened on the carrier element 31. The guide rods 37 extend through the frame opening 34 and are oriented in parallel to the first legs 35. As can be seen from the figures, the sensor parts 32 and 33 are supported by the guide rods 37. For this purpose, the sensor parts 32 and 33 respectively have two openings and are plugged onto or slipped onto the guide rods 37.

The sensor 30 is designed as an inductive sensor 30 and for this purpose in the present case comprises an elongated circuit board 38, on which a coil system 40 having at least one receiver coil 41 is developed, which is only indicated roughly in the figures. In the present case, the coil system 40 comprises one transmitter coil and two receiver coils 41. The coils of the coil system 40 are designed as conductor tracks on the circuit board 38. The circuit board 38 is fastened on the carrier element 31, in the present case by two fastening means 39. The circuit board 38 is situated in such a way that it covers or closes the frame opening 34. The circuit board 38 further comprises a contacting device having multiple electrically conductive conductor plates 42. The conductor plates 42 are situated on a side of the circuit board 38 facing away from the sensor parts 32 and 33. In the present case, there are six conductor plates 42, the conductor plates 42 being situated one behind the other in the displacement direction of the sensor parts 32 and 33. Each of the coils is electrically connected to two respectively different conductor plates of the conductor plates 42.

The sensor parts 32 and 33 respectively comprise a base body 43 and 44, respectively, made of plastic. On a side facing the circuit board 38, the base bodies 43 and 44 respectively have an electrically conductive material. The sensor parts 32 and 33 are arranged in such a way that an electrical voltage of the receiver coil 41 may be influenced or is influenced by a displacement position of the sensor parts 32 and 33.

In order to monitor the displacement position of the pressure force transmitter 20 and of the transmission element 13, the sensor parts 32 and 33 are operatively connected respectively to the pressure force transmitter 20 and to the transmission element 13. This is explained in greater detail below with reference to FIG. 5. A first driver element 45 fastened to the pressure force transmitter 20 is operatively connected to the first sensor part 32 by a first form-locking connection 46 in such a way that the first sensor part 32 can be displaced along with the pressure force transmitter 20. In the present case, the first driver element 45 is developed in one piece with the pressure cap 23. The first form-locking connection 46 is formed in that the first driver element 45 is inserted into a fork-shaped retaining structure 47 of the first sensor part 32. The first driver element 45 and the retaining structure 47 are formed in such a way that the retaining structure 47 exerts a clamping force on the first driver element 45. The clamping force retains the first driver element 45 in the retaining structure 47. Using force of a sufficient magnitude, it is possible, however, to pull the first driver element 45 out of the retaining structure 47 in order to release the form-locking connection 46. The first form-locking connection 46 is thus designed as a releasable clamping connection 46. A second driver element 48 fastened to the transmission element 13 is operatively connected to the second sensor part 33 by a second form-locking connection 49 in such a way that the second sensor part 33 can be displaced along with the transmission element 13. In the present case, the second driver element 48 is developed in one piece with the anti-rotation element 19, so that the second driver element 48 is fastened indirectly to the transmission element 13. The transmission element 13 itself is not illustrated in FIG. 5 for reasons of clarity. The second form-locking connection 49 is formed in that the second driver element 48 is inserted into a fork-shaped retaining structure 50 of the second sensor part 33. The second driver element 48 and the retaining structure 50 are formed in such a way that the retaining structure 50 exerts a clamping force on the second driver element 48. The clamping force retains the second driver element 48 in the retaining structure 50. Using force of a sufficient magnitude, it is possible, however, to pull the second driver element 48 out of the retaining structure 50 in order to release the form-locking connection 49. The second form-locking connection 49 is thus designed as a releasable clamping connection 49. According to a further exemplary embodiment, the first and/or the second form-locking connections 46, 49 are preferably designed as releasable snap-in connections.

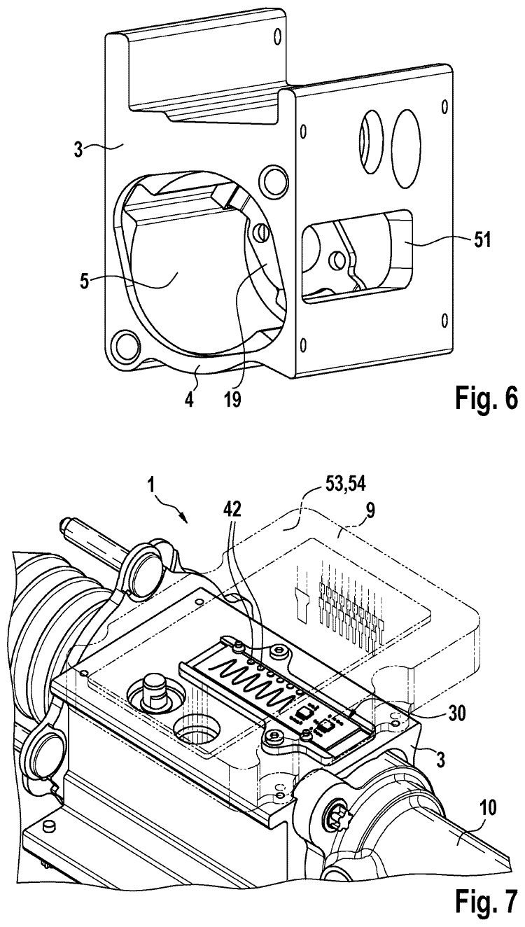

The arrangement of the sensor 30 on the housing 3 is explained in greater detail below with reference to FIGS. 6 and 7. FIG. 6 shows a perspective view of the housing 3. FIG. 7 shows a further perspective view of the actuating device 1, the control device 9 being illustrated semi-transparently in FIG. 7.

As may be seen from FIG. 6, outer wall 4 has an opening 51. The shape of opening 51 is adapted to the sensor 30 or carrier element 31 in such a way that the carrier element 31 is insertable into opening 51 essentially without play. If the sensor 30 is inserted into opening 51 as illustrated in FIG. 7 and is to that extent installed in the actuating device 1 as intended, then the sensor parts 32 and 33 are facing the interior 5 of the housing 3. In particular the retaining structures 47 and 50 extend into the interior 5 of the housing. The sensor 30 is fastened to the housing 3 by two fastening means 52 developed as screws 52 in the present case. As can be seen from FIG. 7, when the actuating device 1 is assembled as intended, the control device 9 is situated in such a way that it covers the sensor 30. An outer wall 53 of a control device housing 54 of the control device 9 has an opening that is not shown in FIG. 7, in which the sensor 30 is situated. The circuit board 38 thus faces directly an interior of the control device housing 54. Control device 9 is electrically connected to the circuit board 38 by the contact plates 42. For this purpose, the control device 9 comprises a number of electrically conductive contact springs corresponding to the number of contact plates 42, the contact springs not being shown in the figures. Each of the contact springs is in contact with a corresponding contact plate 42.

1-14. (canceled)

15. An actuating device for a brake system, comprising:
an actuatable master brake cylinder, including a transmission device which includes a displaceably mounted transmission element, an electric motor configured to drive the transmission device, a displaceably mounted pressure force transmitter which is connected to an input rod in such a way that the pressure force transmitter is displaceable by the input rod, wherein the master brake cylinder is actuatable both by a displacement of the transmission element as well as by a displacement of the pressure force transmitter, and including a sensor which includes a first sensor part that is displaceable together with the pressure force transmitter and a second sensor part that is displaceable together with the transmission element;
wherein the first and the second sensor parts are displaceably mounted on a common carrier element of the sensor.

16. The actuating device as recited in claim 15, wherein the carrier element is frame-shaped, and the first and the second sensor parts are displaceably mounted in a frame opening of the carrier element.

17. The actuating device as recited in claim 15, wherein at least one guide rod is fastened to the carrier element, and the first and the second sensor parts are displaceably supported by the guide rod.

18. The actuating device as recited in claim 15, wherein the first and the second sensor parts are mounted on the carrier element one behind the other in a displacement direction.

19. The actuating device as recited in claim 15, wherein the actuating device includes a housing in which the transmission element and the pressure force transmitter are situated at least partially, and the sensor is fastened on the housing in releasable fashion.

20. The actuating device as recited in claim 19, wherein the sensor is inserted into an opening of an outer wall of the housing.

21. The actuating device as recited in claim 15, wherein: (i) a first driver element is fastened to the pressure force transmitter, the first driver element being connected to the first sensor part by a form-locking connection, and/or (ii) a second driver element is fastened to the transmission element, the second driver element being connected to the second sensor part by a form-locking connection.

22. The actuating device as recited in claim 21, wherein: (i) the first driver element cooperates with a fork-shaped retaining structure of the first sensor part to form the form-locking connection, and/or (ii) the second driver element cooperates with a fork-shaped retaining structure of the second sensor part to form the form-locking connection.

23. The actuating device as recited in claim 21, wherein: (i) the first driver element is fastened to the first sensor part by a releasable snap-in connection or a releasable clamping connection, and/or (ii) the second driver element is fastened to the second sensor part by a releasable snap-in connection or a releasable clamping connection.

24. The actuating device as recited in claim 15, wherein the sensor includes a circuit board fastened on the carrier element, on which at least one receiver coil is formed.

25. The actuating device as recited in claim 24, wherein the circuit board includes at least one electrically conductive contact plate for electrically contacting a control device.

26. The actuating device as recited in claim 24, wherein: (i) the first sensor part includes an electrically conductive material and is situated in such a way that an electrical voltage of the receiver coil can be influenced by a displacement position of the first sensor part, and/or (ii) the second sensor part includes an electrically conductive material and is situated in such a way that the electrical voltage of the receiver coil can be influenced by a displacement position of the second sensor part.

27. The actuating device as recited in claim 19, further comprising a control device situated in such a way on the housing of the actuating device that the control device covers the sensor.

28. The actuating device as recited in claim 27, wherein the control device includes a control device housing and the sensor is situated in an opening of an outer wall of the control device housing.
